(19) United States
(12) Patent Application Publication
(10) Pub. No.: US 2011/0219443 A1
(43) Pub. Date: Sep. 8, 2011

(54) SECURE CONNECTION INITIATION WITH HOSTS BEHIND FIREWALLS

(75) Inventors: Karl Georg Hampel, New York, NY (US); Davide Cherubini, Dublin (IE); Rouzbeh Razavi, Dublin (IE)

(73) Assignees: ALCATEL-LUCENT USA, INC., Murray Hill, NJ (US); ALCATEL-LUCENT IRELAND LTD., Dublin, NJ (US)

(21) Appl. No.: 12/718,565

(22) Filed: Mar. 5, 2010

(51) Int. Cl. G06F 17/00; G06F 15/16

(52) U.S. Cl. 726/11; 709/227

(57) ABSTRACT

The invention is directed to an inter-host signaling protocol, referred to herein as Knock-On Protocol (KOP), for establishing in a secure manner a connection with a host behind firewall. Some embodiments of the invention are directed to a Knock-On Feature (KOF) used in intermediate firewalls or network address translators to enable connection establishment through the FW or NAT to hosts behind the FW or NAT. Advantageously the KOF may include a prefix-based protection feature to protect against address spoofing used in a message flood attack.

### FIELD OF THE INVENTION

The invention is directed to packet data networks, particularly to initiating a secure connection between two host systems, one of which is connected to the packet data network via a firewall. Hereinafter, such connectivity of a host system to a packet data network is referred to as the host system being behind a firewall.

### BACKGROUND OF THE INVENTION

Firewalls (FWs) and network address translators (NATs) apply the following security feature: The FW accepts inbound packets only if they arrive in response to an outbound packet that has passed the FW before. The FW requires that inbound packets match the prior outbound packet with respect to the 5-tuple of {Protocol type, Source IP address, Source Port, Destination IP address, Destination Port}.

This FW security feature allows an inside host (i.e. a host system behind a firewall) to open a connection with any outside host (i.e. a host system not behind the same firewall), unless additional filtering features are applied. Outside hosts, however, cannot solicit connections with inside hosts.

Unfortunately, the FW security feature has the side effect that it prohibits connection establishment initiated by an outside host even if it is desirable to the inside host. A complete dead lock is created when two hosts are behind different FWs and wish to establish a connection. In that case, the two hosts cannot communicate directly with each other.

The FW security feature is also built into most network address translators or network address & port translators, here simply referred to as NATs. Therefore, hereinafter everything stated about FWs is also generally applicable to NATs.

Furthermore, the FW security feature also creates problems for technologies that support host-based mobility like Mobile IPv6 (IETF RFC 3775). These technologies allow a host to move and change its IP address without disrupting ongoing transport connections. The moving host must update its correspondent nodes (CN) about its new IP address using a binding update. However, since the binding update arrives from a new IP address, the security feature will cause the FW to block the binding update.

There are two principle solutions to overcome this undesirable side effect caused by the FW security feature: 1) the FW opens a port for outside hosts to contact inside hosts, and 2) the inside host sustains a signaling connection to an outside relay server (RS) which can be contacted by any outside host. The second solution, for instance, is proposed by the TURN method (draft-ietf-behave-turn-04.txt). The TURN method is further an integral of the Interactive Connection Establishment (ICE) approach (draft-ietf-mmusic-ice-tcp-07) proposed by the IETF.

Both solutions jeopardize the security of the FW since the internal host can become a victim of an attack performed through the open port on the FW or RS. Some variants of the second solution provide additional security on the link between the internal host and the RS. These variants, however, have no impact on the principal vulnerability introduced to inside hosts. It seems that due to this vulnerability, TURN and ICE have not had much acceptance in the market. FW managers tend to disfavor such services and other RS-based methods for the same reason.

In view of the foregoing, it would be desirable to maintain the beneficial security functions of FWs and at the same time allow an outside host to initiate connection establishment with an inside host. Further, where the outside host has moved to a new IP address, it would be desirable to allow a connection established with the inside host to continue.

### SUMMARY

Embodiments of the invention are directed to an inter-host signaling protocol, referred to herein as Knock-On Protocol (KOP), for establishing a connection with a host behind a firewall.

Some embodiments of the invention are directed to a Knock-On Feature (KOF) used by intermediate firewalls or network address translators to enable connection establishment through the FW or NAT to the hosts behind the FW or NAT.

Some embodiments of the invention provide security by limiting the frequency of attempts for an outside host to establish a connection with an inside host.

In embodiments of the invention where the KOF is integrated into a FW or NAT, and in embodiments where the KOF is implemented in series with a FW or NAT, additional security can advantageously be provided by “plugging” (i.e. closing or deleting) open 5-tuple entries after corresponding connections have been terminated.

In some embodiments of the invention the KOF advantageously includes a prefix-based protection feature to protect against address spoofing used in message flood attacks.

Advantageously, typical processing and memory requirements of the KOF according to embodiments of the invention are small compared to those of the FW or NAT.

According to an aspect of the invention a method is provided of establishing a connection between a first host system and a second host system through a firewall providing security protection to second host system. The method comprises, performing by a knock-on-feature (KOF) apparatus, the steps of: receiving a first message sent by the first host system; determining the first message is of a first type for establishing the connection between the first host system and a second host system; determining respective addresses of the first and second hosts systems from the first message; determining if any state information exists on the KOF apparatus for a 2-tuple corresponding to the addresses of the first and second host systems; and sending the first message to the first host system if no said state information for the 2-tuple exists on the KOF apparatus.

Advantageously, the method may further include the steps of: determining an amount of state information existing on the KOF apparatus with respect to the second host system; and combining, responsive to the amount exceeding a predetermined maximum, state information of two host system pairs, each pair comprising the second host system and another host system that is different in each pair, into state information for one host system pair comprising the address of the second host system and an address prefix common to respective addresses of the other host systems of the two host system pairs.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates states and state transitions pertaining to 5-tuples of a typical prior art firewall architecture.

FIG. 2 illustrates the finite state machines (FSMs) for inbound packets (top) and outbound packets (bottom) of a typical prior art firewall architecture. The flow charts do not include 5-tuple state transitions shown in FIG. 1 that are due to timer expiry.

FIG. 3 illustrates respective network architectures for (a) KOF integrated into a FW, (b) KOF in series to a legacy FW, and (c) KOF on external RS, according to embodiments of the invention;

FIG. 4 illustrates KOP message call flows of the integrated KOF firewall architecture according to the embodiment depicted in FIG. 3 part a;

FIG. 5 illustrates states and state transitions pertaining to 5-tuples and 2-tuples of the integrated KOF firewall architecture according to the embodiment depicted in FIG. 3 part a;

FIG. 6 illustrates states and state transition pertaining to 5-tuples and 2-tuples of the KOF in series with legacy firewall architecture according to the embodiment depicted in FIG. 3 part b;

FIG. 7 illustrates KOP message call flows of the KOF provided in external RS architecture according to the embodiment depicted in FIG. 3 part c;

FIG. 8 illustrates the FSMs for inbound packets of the integrated KOF firewall architecture according to the embodiment depicted in FIG. 3 part a. The flow charts do not include state transitions shown in FIG. 5 that are due to timer expiry.

FIG. 9 illustrates the FSM for outbound packets of the integrated KOF firewall architecture according to the embodiment depicted in FIG. 3 part a. The flow charts do not include state transitions shown in FIG. 5 that are due to timer expiry.

FIG. 10 illustrates FSMs for inbound packets of the KOF in series with firewall architecture according to the embodiment depicted in FIG. 3 part b. The flow charts do not include state transitions shown in FIG. 6 that are due to timer expiry.

FIG. 11 illustrates FSMs for outbound packets of the KOF in series with firewall architecture according to the embodiment depicted in FIG. 3 part b. The flow charts do not include state transitions shown in FIG. 6 that are due to timer expiry.

In the figures like features are denoted by like reference characters.

### DETAILED DESCRIPTION

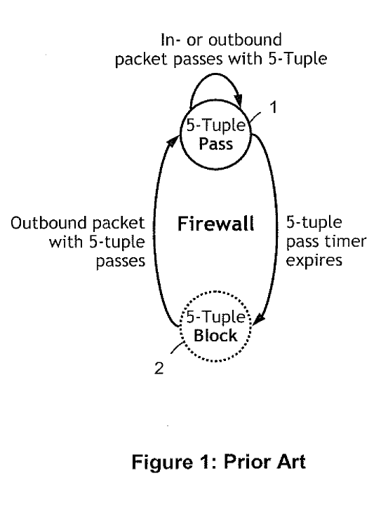

In reference to FIG. 1, on the FW every 5-tuple pertaining to an actually or potentially existing connection can be associated with either of two states: a Pass state 1 or a Block state 2, where the associated Pass and Block functions apply to inbound packets. Each 5-tuple changes from Block state 2 to Pass state 1, when an outbound packet with this 5-tuple is passing. The Pass state 1 is associated with a life time. After life-time expiration the 5-tuple returns to the Block state 2. In Pass state 1, the timer can be refreshed with every outbound or inbound packet holding the corresponding 5-tuple.

In the typical FW implementations, only 5-tuples in Pass state 1 require allocation of cache memory. Since the Block state 2 is the default state and does not carry time-sensitive information, it does not require allocation of cache. The following data are typically held on the FW for a 5-tuple in Pass state: 5-tuple and expiration time.

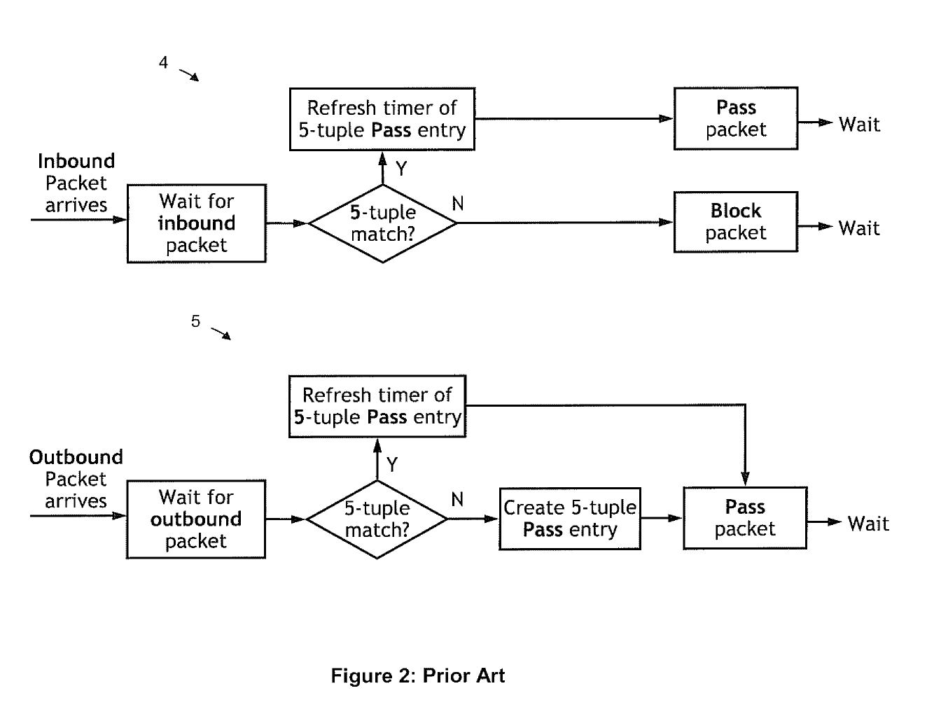

In reference to FIG. 2, the FW function can be represented through two finite state machines (FSMs). One state machine 4 handles inbound packets, the other state machine 5 outbound packets. Note that the FSM-diagrams in FIG. 2 omit state transitions due to state expiry.

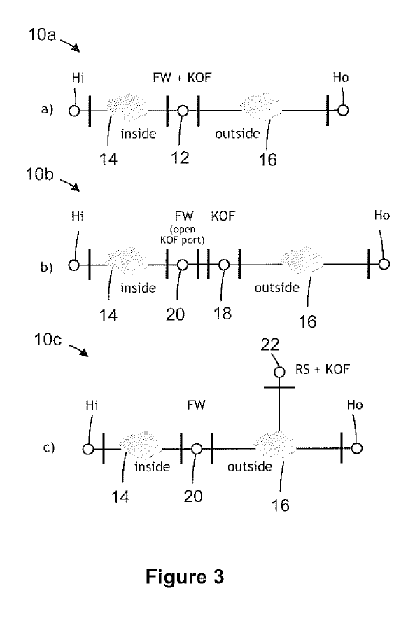

With reference to FIG. 3, the KOP should be used by end hosts as a courtesy procedure to frame inter-host connection management. Additional functionality, such as authentication for instance, can be embedded into these messages.

The KOP messages can be intercepted, evaluated and acted upon by the KOF on a FW. Based on some conditional rule set, inbound KOP messages can be passed by the KOF on the FW to an inside host. Due to careful definition of KOP messages and the KOF rule set, connection establishment through the FW can be provided in a very secure manner. The following sections outline how the KOF is designed so that it does not impair the FW's security function.

KOP messages are based on a transport connection given by a 5-tuple. Therefore, KOP messages carry the corresponding 5-tuple information. The KOP supports the following messages:
KOP REQ: Requests connection establishment on behalf of a specific 5-tuple.
KOP ACK: Accepts connection establishment in response to a KOP REQ message.
KOP NAK: Declines connection establishment in response to a KOP REQ message.
KOP RSP: Requests more information in response to a KOP REQ message. The reply to this message would be another KOP REQ message.
KOP FIN: Terminates a 5-tuple connection.

The first four messages above are used prior to, or at, the time of connection establishment, and the last message at, or after, connection termination. During the life-time of a connection, a KOP client on a host need not keep any state information.

Apart from the 5-tuple, KOP messages can principally carry any additional information. For example, the KOP REQ message could carry embedded information that convinces a peer host to engage into a connection as, for instance, the sending host's authentication credentials. The KOP RSP message allows the peer host to request additional information. By using KOP REQ/RSP message pairs, more complex handshakes can be established.

KOP messages can use a Type-Length-Value format to hold information. KOP messages can use the following transport formats:
KOP messages can use UDP with a specific port number. In the following, this approach is used for the KOP unless stated differently.
KOP messages can carry their own protocol type.
KOP messages can use ICMP.
The KOP information can be embedded into an IP-options header (IPv4) or IP-extension header (IPv6). This would be an especially good solution for IPv6.
KOP messages can also be implemented into specific transport protocols. In the case of TCP, for instance, the TCP options header could be used to flag KOP messages. The KOP REQ message, for instance, could be piggy-backed onto a TCP SYN message.
KOP information can be included into existing signaling protocols, e.g. IKEv2 (IETF RFC 4306).

A KOP-capable host is a host system that can create, send, receive, interpret, and respond to KOP messages for the purpose of establishing and terminating a connection with another host or rejecting a connection initiation request from another host using KOP messages. Preferably, KOP-capable hosts are able to interoperate with legacy hosts. For example, when a KOP-capable host sends a KOP REQ message to a legacy host to establish a connection, no response will occur. In this case, the KOP-capable host may simply give up after a few retransmissions and try to establish a connection with the legacy host in a conventional manner.

Since a purpose of the KOP is to overcome middle boxes such as FWs and NATs, the connection-initiating host may even attempt to establish a connection in parallel to sending a KOP REQ message or after conventional connection establishment has failed. Note that only a FW with KOF will let the KOP REQ message pass. When a receiving host (i.e. a host to which a KOP REQ message is sent) is KOP-capable, it has the opportunity to respond to a KOP REQ message with a KOP NAK or KOP RSP message without engaging in a connection with the connection-initiating host. When the receiving host is a legacy host and not behind a FW, however, the connection can be initiated without delay. This means that conventional call-establishment procedures still work properly when one of the hosts is not KOP-capable.

Care should be taken when the KOP information is carried on IP-options, IP-extension, or TCP-options headers that are multiplexed with a TCP SYN packet of a traffic connection. For example, the KOF feature on intermediate FWs could react to the KOP part of the packet i.e. let it pass, while a receiving legacy host simply discards the KOP part of the message and responds to the TCP SYN packet with TCP SYNACK. This would essentially disable the security function of the FW.

The KOP ACK message is in principle unnecessary since a KOP-capable receiving host can simply take the initiative and start a connection in response to a KOP REQ message. To accommodate this case, the sender of the KOP REQ message can start the connection in parallel at its end. This would create a 5-tuple on its own firewall which would let an incoming traffic packet sent by the receiving host pass.

Referring to FIG. 3, a KOF can be provided in three manners as shown in respective network architectures 10a to 10c, in which an inside host Hi is communicatively connected to an outside host Ho via an inside network 14 behind a FW and an outside network 16 on the other side of the FW. Accordingly, the KOF can be provided in a first manner shown a) as an integrated KOF firewall 12, in a second manner shown in b) as a KOF 18 added in series to a FW 20 which may be a legacy firewall, or in a third manner shown in c) with the KOF provided on a public Relay Server (RS) 22.

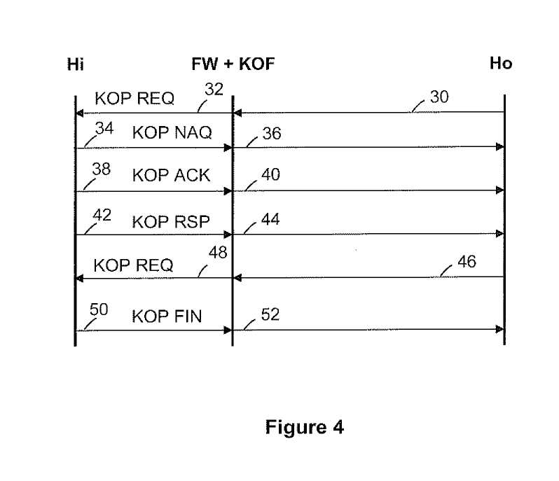

FIG. 4 shows an example call flow of connection establishment and termination for the case of the integrated KOF firewall 12 according to the first network architecture 10a. These call flows are also applicable to the second network architecture 10b in which the KOF 18 is added in series to the FW 20.

Referring to FIG. 4, the outside host Ho attempts to initiate a connection with the inside host Hi by sending 30 a KOP REQ message to the inside host Hi. The integrated KOF firewall 12 receives the KOP REQ message and recognizing it as a KOP message, forwards 32 the message to the inside host Hi. The inside host Hi can respond to the KOP REQ message by sending 34 a KOP NAK message to the outside host Ho. The integrated KOF firewall 12 receives the KOP NAK message and recognizing it as a KOP message, forwards 36 the message to the outside host Ho. Since the KOP NAK message indicates that the inside host Hi declines establishment of the requested connection, upon receipt of the message the outside host Ho does not establish the requested connection. Instead of the KOP NAK, the inside host Hi can send 38 a KOP ACK message to the outside host Ho, that message indicating the inside host Hi accepts establishment of the requested connection. The integrated KOF firewall 12 receives the KOP ACK message and recognizing it as a KOP message, forwards 40 the message to the outside host Ho. Upon receipt of the KOP ACK message, the outside host Ho begins to establish the requested connection.

As an alternative to sending a KOP ACK or a KOP NAK message, the inside host Hi can send 42 a KOP RSP message to the outside host Ho to request additional information. The integrated KOF firewall 12 passes 44 the KOP RSP message to the outside host Ho as well as passing 48 a second KOP REQ message that the outside host Ho sends 46 to the inside host Hi in response to the KOP RSP message. Upon receiving the second KOP REQ message, the inside host Hi has the same options as before when the first KOP REQ message was received. In the case where the inside host Hi has established a connection and wishes to terminate this connection, the inside host Hi signals the outside host Ho that the connection is to be terminated by sending 50 a KOP FIN message thereto via the integrated KOF firewall 12 which passes 52 the message to the outside host Ho.

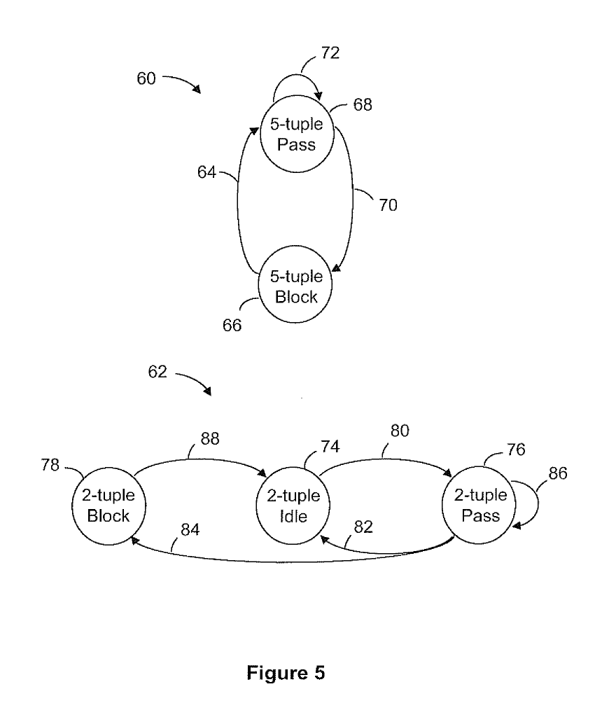

Referring to FIG. 5, the integrated KOF firewall 12 function can be associated with 5-tuples 60 pertaining to inbound traffic packets and 2-tuples 62 pertaining to inbound KOP REQ packets. A 5-tuple 60 state determines if an inbound traffic packet should be passed or blocked. A 2-tuple 62 state determines if an inbound KOP REQ message should be passed or blocked. The 2-tuple refers to the {Hi, Ho} IP address pair where Hi represents the inside host Hi and Ho represents the outside host Ho. Note that the outside host Ho can also reside behind its own FW.

Generally, KOP messages are only passed if there is a corresponding 2-tuple entry which is in a Pass state. If such an entry does not exist, the KOF will create such an entry and set it to the Pass state. The KOF will not pass a KOP REQ message if there is a corresponding 2-tuple entry in a Block state. This bimodal behavior of 2-tuples provides the following functionality: the Pass state checks if the arrival rate of KOP REQ messages is below a critical level, and if so then KOP REQ messages will be allowed to pass; otherwise the Block state will be invoked to protect the inside host Hi from the arrival of further KOP REQ messages.

While each 5-tuple can be in either Pass state 68 or in Block state 66, each 2-tuple can be in one of Idle state 74, Pass state 86 or Block state 78. The KOF integrated FW does not hold any cache memory for the 5-tuple Block state 66 or the 2-tuple Idle state 78 since these states are the default states and they do not carry any time-sensitive information. For the 5-tuple Pass state 68, the KOF-integrated FW caches the 5-tuple and an expiry time. For the 2-tuple pass state 86 it caches the 2-tuple, an expiry timer and a message counter. For the 2-tuple Block state 78, it caches the 2-tuple and an expiry timer.

The KOF integrated FW 12 maintains 72 a 5-tuple Pass state 68 entry to an existing connection between an inside host Hi and an outside host Ho or a connection establishment attempt by the inside host Hi. The KOF integrated FW 12 maintains 86 a 2-tuple Pass state entry {Hi, Ho} to control the rate of inbound KOP REQ messages when the outside host Ho attempts to establish a connection with the inside host Hi. The KOF integrated FW 12 maintains a 2-tuple Block state 78 entry to protect the inside host Hi from further KOP REQ message attempts by the outside host Ho in case such messages are not desired by the inside host Hi or the outside host Ho has exceeded the acceptable rate of KOP REQ messages it has sent to the inside host Hi.

The functionality based on 5-tuples 60 is similar to that provided by a conventional FW with some exceptions. First, its blocking function does not apply to inbound KOP REQ messages. Instead, inbound KOP REQ messages are subject to the state of their associated 2-tuple 62. Second, the 5-tuple 60 entry is not created upon traversal of outbound KOP REQ, RSP or FIN messages.

In addition to conventional FW functionality, the 5-tuple 60 undergoes a transition 64 from a Block state 66 to Pass state 68 when an outbound (i.e. sent from the inside host Hi) KOP ACK message corresponding to the 5-tuple is passed through the integrated KOP firewall 12. This transition 64 also occurs when an ordinary packet (i.e. a packet not carrying a KOP message) is passed through the integrated KOP firewall 12.

In addition to the conventional FW functionality, the 5-tuple 60 further undergoes a transition 70 from the Pass state 68 to the Block state 66 when an outbound KOP FIN packet corresponding to the 5-tuple 60 is passed through the integrated KOP firewall 12. This feature allows the inside host Hi to close a 5-tuple entry on a FW for a connection that has terminated, which provides substantial security to the inside host Hi since the entry, which could otherwise become a “security hole” (or security vulnerability) can be closed by inside host Hi.

The integrated KOP firewall 12 includes a timer for the Pass state 68 of each 5-tuple, which timer upon expiring causes the transition 70 from the Pass state 68 to the Block state 66. Otherwise, the 5-tuple 60 maintains 72 the FW state in the Pass state 68, with the passage through the integrated KOP firewall 12 of inbound or outbound packets corresponding to the 5-tuple 60. The functionality associated with the timer in Pass state 68 as well as transition 70 from the Pass state 68 is the same as for a conventional firewall.

Every 2-tuple 62 is based on the {Hi IP address, Ho IP address}-pair contained in KOP messages between an inside host Hi and an outside host Ho. The KOF integrated FW 12 maintains the 2-tuple 62 in one of three states: an Idle state 74, a Pass state 76, and Block state 78. The KOF-integrated FW 12 operates in the following manner. When in the Idle state 74 and an inbound KOP REQ message arrives for the corresponding inside host Hi, the 2-tuple 62 transitions 80 to the Pass state 76 and lets the KOP REQ message pass through the integrated KOF firewall 12. The Pass state 76 has a lifetime attribute and a max-count attribute. During the lifetime of the Pass state 76, which is determined by the value of the lifetime attribute, only a maximum number, equal to the value of the max-count attribute, of KOP REQ messages can be forwarded for this 2-tuple. If the lifetime of the Pass state 76 expires before this maximum number of KOP REQ messages is reached, the 2-tuple 62 transitions 82 to the Idle state 74. If the maximum number of KOP REQ messages is reached before the Pass state 76 lifetime expires, the 2-tuple 62 transitions 84 to the Block state 78. Otherwise the 2-tuple 86 in the Pass state 76 refreshes 86 the Pass state with the passage of outbound KOP REQ and KOP RSP messages of the 2-tuple through the integrated KOF firewall 12. The transition 86 resets the Pass-state timer and the Pass-state counter of the Pass state 76. In the Block state 78, further inbound KOP messages from the outside host Ho to the inside host Hi are rejected by the integrated KOF firewall 12. The Block state 78 has its own lifetime attribute, the value of which determines the lifetime of the Block state 78. After expiration of the Block-state's 78 lifetime the 2-tuple 62 transitions 88 to the Idle state 74.

If the inside host Hi receives a KOP REQ message and it is not interested in establishing the requested connection, the inside host Hi can respond to the connection-initiating outside host Ho with a KOP NAK message. This KOP NAK message will cause the 2-tuple 62 on the KOF integrated FW 12 to transition 84 from the Pass state 76 directly to the Block state 78, which will cause the integrated KOF firewall 12 to block further KOP REQ messages sent from the outside host Ho to the inside host Hi.

In the case where the KOF state is in the Pass state 76 and the corresponding inside host Hi sends an outbound KOP RSP message to request more information from the corresponding outside host Ho, the KOF integrated FW 12 resets Pass-state timer and a Pass-state counter for the 2-tuple 62. The KOF integrated FW 12 uses the Pass-state timer and Pass-state counter to determine whether the corresponding Pass state lifetime has expired for that 2-tuple 62 or whether a maximum number of messages allowed while in the Pass state 76 has been reached. This reset capability gives outside host Ho an opportunity to respond to the KOP RSP message with a KOP REQ message including any retransmissions that may be necessary.

The KOP RSP and ACK messages sent by the inside host Hi can also serve as a KOP REQ message in the case where the outside host Ho also resides behind a FW. A KOP REQ/RSP or REQ/ACK message handshake would therefore clear the path on both firewalls. Such a handshake enables connection establishment in a secure manner when both hosts are behind firewalls.

With this set of features, the KOF provides the following protection via the integrated KOF firewall 12: while it opens the FW to pass a certain type of control message to the inside host Hi, it restricts the inbound packet flow of such messages to max-count per Pass state 76 lifetime. If this rate (determined by the values of the Pass state 76 max-count and lifetime attributes) is exceeded by an outside host Ho, the Block state 78 protects the inside host Hi from additional KOP REQ messages for some extended period of time. The value of the Pass state 76 lifetime attribute is advantageously set to a few seconds so that multiple KOP REQ message retransmissions can be accommodated. The value of the Block state 78 lifetime attribute should result in a longer lifetime than the Pass state's 76 lifetime, so that Block state 78 protects the inside host Hi from KOP REQ message flood attacks (e.g. the Block state's 78 lifetime would be in minutes or even hours).

To improve on the aforementioned protection provided by the KOF in the integrated KOF firewall 12, the packet length of KOP messages could be restricted to a specified maximum length. It is advisable to keep the total message length below 576 octets, which means that packet fragmentation is not applied. Accordingly, before acting on a KOP message, the KOF would evaluate the length of the packet carrying the KOP message and discard the packet if its length exceeds the specified maximum length.

For further enhancing protection provided by the KOF, a specific TLV format could to be introduced for KOP messages. While this format would be flexible in type definition and value length, it would provide additional protection for hosts by enabling the integrated KOF firewall 12 and hosts to discard KOP messages whose type definition they do not recognize.

Note that the KOF does not prohibit inside hosts from establishing connections with outside hosts whose KOP REQ messages they have rejected. This capability means that the KOF integrated FW 12 can maintain 5-tuple 60 in the Pass state 68 even though the 2-tuple 62 of the corresponding host pair is holding the Block state 78. This behavior is important since it makes the integrated KOF firewall 12 compliant with legacy FW functionality.

The states of the 2-tuple 62 can be implemented in rather simple fashion: since the Idle state 74 does not hold any time-sensitive information, it does not require allocation of memory. Therefore, only 2-tuples in the Pass state 76 or in the Block state 78 are held in memory. For this purpose, the following data structures are held in memory:

KOF Pass State:
2-tuple
Expiration time (time when Pass state lifetime will expire)
Counter (counts number of KOP messages either up to, or down from, the value of the max-count attribute)
   The KOF Pass state expiration time implements the aforementioned Pass-state timer and the KOF Pass-state counter implements the aforementioned Pass-state counter.

KOF Block State:
2-tuple
Expiration time (time when the Bock state lifetime will expire)

Under normal operation, the number of KOF states to be held in memory would be negligible. This number, however, can grow substantially during a message flood attack. Under such circumstances prefix-based protection, which is described in the next section, would be beneficial.

### Prefix-Based Protection

While the KOF integrated FW 12 limits the rate of KOP REQ messages that arrive at each inside host Hi, it should also protect the inside hosts from flood attacks of KOP REQ messages. This includes attacks that lead to overload of the KOF itself. Under such circumstances, the KOF should rather temporarily subside its functionality which reverts the integrated KOF firewall 12 functionality to that of a conventional FW.

The KOF can become vulnerable to a flood of KOF REQ messages originated from a multitude of spoofed IP addresses and directed toward one inside host Hi. That is because the KOF would maintain one entry 62 for every resulting 2-tuple of the KOF REQ messages originating from every spoofed IP address, which would result in the integrated KOF firewall 12 letting the entire flood of messages pass.

In principle, IP address spoofing is undermined through ingress filtering by intermediate routers. However, ingress filtering is not always enforced. Further, attackers may still be able to spoof IP addresses pertaining to the same L2 network, i.e. one L3 subnet.

The KOF can protect against such flood attacks by extending the primitive 2-tuple of {Hi IP address, Ho IP address} introduced above to the following prefix-based form of {Hi IP address, Ho IP prefix}. In the prefix-based form, all incoming KOP REQ messages for the inside host Hi that are compliant with outside host's Ho prefix would be handled by the same 2-tuple 62 using the same KOF state.

The extension of a 2-tuple 62 from the primitive to the prefix-based form needs to be done gradually since blocking based on IP prefix may also reduce accessibility for a large number of friendly hosts. A variety of algorithms can be introduced for this purpose. One simple and very effective method is the following:
For each inside host Hi, the KOF can only maintain a certain maximum number N of 2-tuples that are in either Pass state 76 or Block state 78 since these two states require memory allocation. The 2-tuples that hold either of these two states are referred to as 2-tuple entries.
When the number of 2-tuples entries for inside host Hi reaches N and a new inbound KOF REQ arrives for the inside host Hi resulting in the generation a new 2-tuple entry in Pass state 76, two of the inside host's 2-tuples entries have to be combined into a single 2-tuple entry. The combined 2-tuple entry uses the intersection of the IP addresses of the outside hosts Ho, each corresponding to a respective one of the aforementioned two 2-tuple entries, as a “prefix”. Note that the term prefix is not used in the sense of subnet assignment here.
If both 2-tuple entries have the same state (Pass state 76 or Block state 78), this state is carried over to the combined 2-tuple entry. If this state is the Pass state 76, the counter of the combined 2-tuple entry is set to the maximum of the counters of the prior 2-tuple entries, and the combined expiry time is set to the minimum of the expiration times of the prior 2-tuple entries. If this state is the Block state 78, the expiration time of the combined 2-tuple entry is set to maximum of the expiration times of the prior 2-tuple entries.
If both 2-tuple entries have different state (one is in the Pass state 76 and the other in the Block state 78), the combined 2-tuple entry is set to the Block state 78 and the expiration time is reset.
The selection of the 2-tuple entry is used for the combining procedure can be based on longest prefix for the merged 2-tuple. The longer this prefix is the smaller is the topological distance between the IP addresses of the outside Hosts. The computational effort of this selection process is rather small since the number N can be chosen rather small.
Example: N=3:
The inside host Hi already has N=3 2-tuple entries when a new KOF REQ arrives for the inside host Hi:

| | Hi's IP | Ho's IP | | Message | |
|---|---|---|---|---|---|
| State | address | address | State | counter | Expiration time |
| 1 | 100.1.1.0 | 200.1.1.5 | Pass | 3 | Now + 6544 msec |
| 2 | 100.1.1.0 | 223.1.1.4 | Pass | 5 | Now + 897 msec |
| 3 | 100.1.1.0 | 200.1.2.3 | Pass | 1 | Now + 3120 msec |
| New | 100.1.1.0 | 114.2.45.4 | Pass | 1 | Now + 9000 msec |

2-tuple entries 1 & 3 are combined because they have largest common prefix, which results in the following:

| | Hi's IP | Ho's IP | | Message | |
|---|---|---|---|---|---|
| State | address | address | State | counter | Expiration time |
| 1 | 100.1.1.0 | 200.1.X.X | Pass | 3 | Now + 3120 msec |
| 2 | 100.1.1.0 | 223.1.1.4 | Pass | 5 | Now + 897 msec |
| 3 | 100.1.1.0 | 114.2.45.4 | Pass | 1 | Now + 9000 msec |

The combined KOF state, now shown as state 1, has an outside host Ho IP address of 200.1.X.X. which is in the so-called prefix-based form due to the ‘X.X’ used for the least significant two octets of the IP address. The ‘XX’ matches all values for the corresponding octets of IP address of outside hosts. Further, the Pass-state counter (message counter) of the combined KOF state is set to three, which is the greater of the values of the Pass-state counters of prior KOF states 1 and 3. The Pass-state timer (expiration time) of the new KOF state is set to ‘Now+3120 msec’ which is the shorter of the Pass-state timers of the prior KOF states 1 and 3.

The KOF need not keep any information about the history of 2-tuple entry combining. The state transitions apply to prefix-based states in the same fashion as to conventional IP-address-based states. Once the Idle-state 74 is reached, state bundling information is lost since no memory is kept in the Idle state 74. This mechanism smoothly reverses the state bundling and allows the KOF to relax to its normal operation mode.

The above combining process is based on the maximum number N of 2-tuple entries for an inside host Hi. This number can be adjusted dynamically. Either, a fixed value for N is allocated to each inside host Hi, or alternatively, one common pool of 2-tuple entries can be allocated on behalf of all inside hosts Hi. If this pool is filled and new 2-tuple entries are to be added, the inside host Hi with the largest number of 2-tuples can be selected. If this pool is smaller than the number of inside hosts Hi, it can happen that the pool is filled while every inside host Hi does not hold more than one 2-tuple entry. In this case, the same combining procedure can be applied with respect to the Hi-IP addresses. In this case, 2-tuple entries can hold prefixes on behalf of inside host Hi as well.

With prefix-based protection, a flood attack of KOF REQ messages on an inside host Hi using a pool of source IP addresses leads to one 2-tuple entry in the Block state 78 with the outside host Ho IP address prefix pertaining to the attacker's subnet. All further KOP REQ messages to that inside host Hi from the attacker will be blocked by the integrated KOP firewall 12. At the same time, the integrated KOP firewall 12 will operate normally with respect to an outside host from another subnet that attempts to establish a connection with the inside host Hi.

Note that such flood attacks are usually limited to the IP addresses pertaining to one subnet since ingress filtering of intermediate routers discards packets of mysterious origin. Even in the unlikely event where the attacker spoofs IP addresses from the entire Internet, prefix-based protection would end up blocking all incoming KOF REQ messages. In this limit, the integrated KOF firewall 12 would provide the same protection as a conventional FW.

In addition to protecting internal hosts Hi from KOP REQ message flood attacks, prefix-based protection advantageously limits the amount of memory needed for the 2-tuple entries, Further advantageously, prefix-based protection reduces computational effort when new KOP REQ messages arrive for an inside host Hi since only a small number of KOF states are held for the respective host.

Knock-On Feature in Series with Legacy Firewall

Referring again to FIG. 3, in particular to the second network architecture 10b, the KOF 18 can also be added as a separate function in series to a firewall 20. This is especially easy to accomplish if UDP-based KOP messages are used. In this case, the corresponding UDP port would be opened on the firewall.

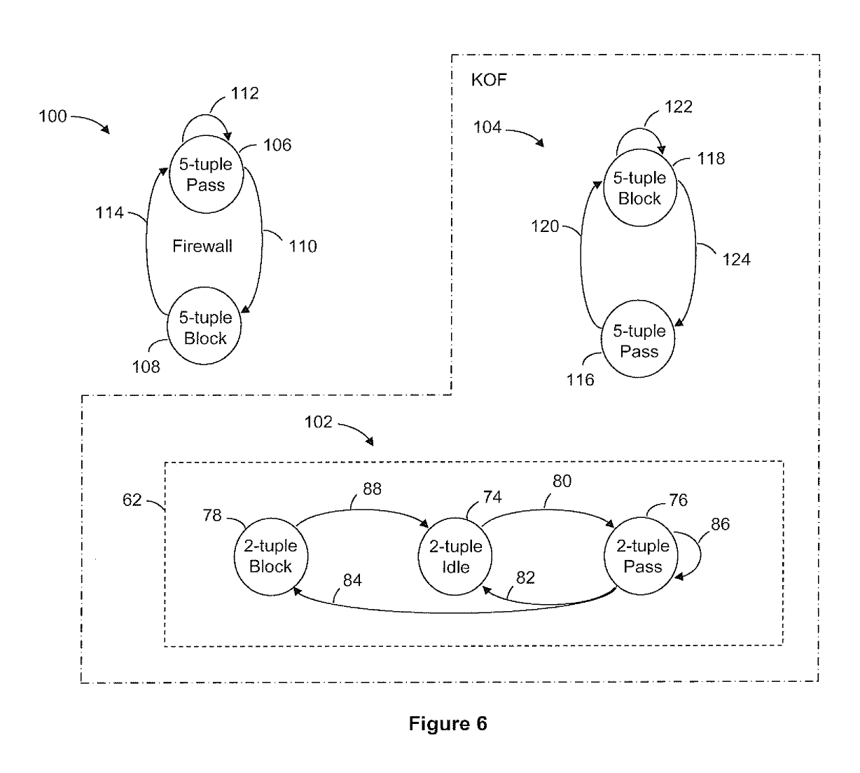

FIG. 6 illustrates 5-tuple and 2-tuple states and state transitions of the KOF 18 and firewall 20 of the second network architecture 10b, in which the KOF 18 is in series with the firewall 20. The firewall 20 in this case is a legacy firewall supporting 5-tuple 100 that provides conventional firewall functionality. The KOF 18 supports 2-tuples 102 that operate in the same manner as the 2-tuples 62 previously described with respect to the integrated KOF firewall 12, and 5-tuples 104.

The 5-tuple 100 maintains a state for a corresponding 5-tuple associated with a connection between an inside host Hi and an outside host Ho. The FW 20 controls whether a particular 5-tuple should remain in a Pass state 106 or in a Block state 108, or make a transition from the Pass state 106 to the Block state 108 or visa versa. While in the Pass state 106 a pass-timer is updated, and upon expiration of the pass-timer the 5-tuple 100 state will transition 110 from the Pass state 106 to the Block state 108. Otherwise, the FW state will remain 112 in the Pass state as long as inbound or outbound packets of the corresponding 5-tuple are passed through the firewall 20. When remaining in the Pass state 106, the timer associated with the Pass state 106 is reset. While in the Block state 108, the FW state will transition 114 from the Block state 108 to the Pass state 106 when an outbound packet of the corresponding 5-tuple is passed by the firewall 20.

The KOF 18 maintains 2-tuples associated with inbound KOP REQ messages between an inside host Hi and an outside host Ho. Since the firewall 20 bridges KOP messages, the KOF 18 can operate 2-tuples 102 in this second network architecture 10b in the same manner as the KOF integrated FW 12 operated 2-tuples 62. For simplicity of the foregoing description of this embodiment, the KOF 18 handling of 2-tuples 102 will be understood to be implemented in an identical manner as for the 2-tuples 62 in the KOF integrated FW 12.

Unlike the integrated approach of the first network architecture 10a, the KOF 18 of the second network architecture 10b acts on 5-tuple 104 in series to the FW 20 acting on 5-tuples 100. The 5-tuple maintained by the KOF 18 corresponds to any actual or potential connection between inside host Hi and an outside host Ho. The KOF 18 controls whether the 5-tuple 104 should remain in a Pass state 116 or in a Block state 118, or make a transition from the Pass state 116 to the Block state 118 or visa versa. The KOF 18 supports KOP FIN messages, i.e. to block incoming traffic packets of the 5-tuple to the inside host Hi based on an outbound KOP FIN message from the inside host Hi. Accordingly, when the KOF 5-tuple state 104 is in the Pass state 116 and a KOP FIN message corresponding to the 5-tuple 104 is passed through the KOF 18 in outbound direction, the 5-tuple 104 in Pass state 116 transitions 120 to the Block state 118. Otherwise, if the KOF 5-tuple state 104 is already in the Block state 118 when the KOP FIN message is passed through the KOF 18, the KOF 5-tuple state 104 remains 122 in the Block state 118 and resets the 5-tuple Block state timer. If the Block state timer expires or if an outbound packet corresponding to the 5-tuple is passed through the KOF 18 from the inside host Hi, the 5-tuple 104 transitions 124 the from the Block state 118 to the Pass state 116. The Block state timer expires after a time equivalent to the time taken for the pass-state timer of the 5-tuple 100 to expire.

While the 5-tuple 100 can be realized by implementing only the Pass state 106 for the 5-tuple 100, the KOF's 5-tuple 104 can be realized by implementing only the Block state 118 for the KOF's 5-tuple 104. Accordingly, the memory requirements for the KOF's 5-tuple 104 would be approximately the same or less as for those of the FW's 5-tuple 100. That is, regarding the FW's 5-tuple 100, the FW states in the Pass state 106 occupy memory for the lifetime of their corresponding connections plus the lifetime of the Pass state 106. Whereas, for the KOF's 5-tuple 104, KOF 5-tuple states in the Block state 118 occupy memory only for the Block state's 118 lifetime, which is determined by a respective Block state timer, and as previously mentioned, a Block state timer expires after a time equivalent to the time taken for the pass-timer of the FW's 5-tuple 100 Pass state 106 to expire.

The combination of the 5-tuple 100 operation and the KOF 5-tuple 104 operation of the second network architecture 10b, accomplish the same function as the 5-tuple 60 operation in the integrated KOF firewall 12. The serial solution of the second network architecture 10b, however, does not support KOF ACK messages. Advantageously, the effect of a KOF ACK message can be achieved by a normal traffic packet.

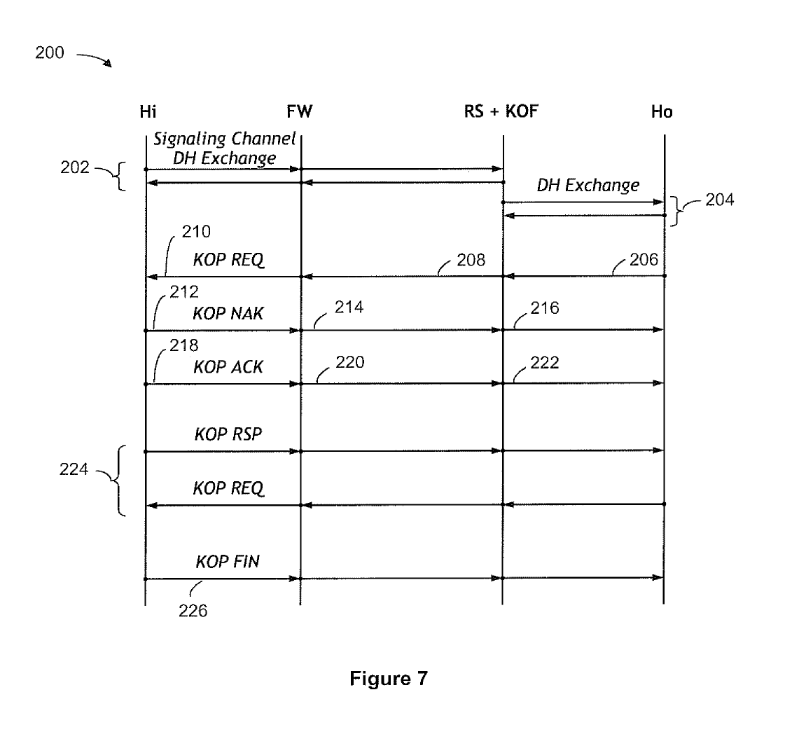

Referring to FIG. 7 and the corresponding third network architecture 10c, in which the KOF is provided on a relay server (RS) 22 that supports a legacy FW 20. The RS 22 is assumed to be in the public internet or at least addressable from the public internet. Further, the inside host Hi has a signaling connection to the RS 22. We assume that inside host Hi uses a domain name server (DNS), for instance, to publish an IP address, protocol type and port of the RS 22, through which it can be reached.

To provide an equivalent level of security as that of the integrated KOF firewall 12, in the third network architecture 10c the traffic along the signaling connection between the inside host Hi and the RS 22 is integrity protected. This is done since the signaling traffic passes the public internet and is therefore vulnerable to integrity attacks.

When the outside Ho sends a KOP REQ message to the RS 22, the outside host Ho needs to explicitly refer to the inside host Hi in the payload of the KOP REQ message. This is different to the first network architecture 10a where the integrated KOF firewall 12 can infer the inside host Hi from the IP header of the KOP REQ message. In the same fashion, the outside host Ho can add information about protocol type and port number in the payload of the KOP REQ message.

This approach, however, adds vulnerability. That is, since the IP address of the inside host Hi is not used for routing purposes, but solely carried in the payload of the KOP REQ message, it can be altered by any attacker. To overcome this vulnerability, the outside host Ho must protect the integrity of the KOP REQ message sent to the RS 22.

This integrity protection of a KOP REQ message can be accomplished via public/private key pairs or shared keys. A security association using Diffie-Hellman (DH) exchange, for instance, should be sufficient. To break such shared keys based on DH exchange, a man-in-the-middle (MitM) system would be required that sustains separate connections with each end. In this procedure, the MitM system would need to be able to spoof the IP addresses of the respective end-points without falling victim to ingress filtering by intermediate routers. If such a MitM system exists, it would also be able to overcome the FW 20 directly, i.e. by spoofing IP addresses to existing 5-tuple entries on the FW 20. Therefore, using DH-based keys for KOP message exchanges between the RS 22 and the outside or inside hosts Ho/Hi should be sufficient for integrity protection of these exchanges since it will provide at least the same level of protection as would the legacy FW 20.

Referring to FIG. 7 and also to FIG. 3 part c, an example message call flow 200 between the RS 22 and the outside and inside hosts Ho/Hi occurs as follows:
The inside host Hi and the RS 22 establish 202 a secure signaling connection using DH exchange. This creates a first 5-tuple entry on the FW 20, which entry corresponds to the inside host Hi and the RS 22.
The outside host Ho establishes 204 a secure connection with RS 22 using DH exchange.
The outside host Ho sends 206 a KOP REQ message to the RS 22 after first integrity protecting the message. The payload of the KOP REQ message contains the inside host's Hi data using predefined parameter types. This data includes an IP address, protocol type and port number of the inside host Hi to be used for the proposed connection.
The KOF residing on the RS 22 evaluates the KOP REQ message. For that purpose it uses the same 2-tuple 62 operation previously described with respect to the first and second network architectures 10a and 10b.
If the KOF state for the 2-tuple corresponding to the IP addresses of the inside and outside hosts Hi and Ho is not in the Block state 78, the RS 22 tunnels 208 the KOP REQ message to the inside host Hi through the signaling link. The RS 22 provides integrity protection for the KOP REQ message, as previously described. The KOP REQ message includes the IP address of the outside host Ho.
The FW 20 lets the KOP REQ message pass 210 since the signaling link on which the message is carried has already been established, as described previously with respect to the creation of the first 5-tuple entry on the FW 20
The inside host Hi uses information in the KOP REQ message to directly contact the outside host Ho. This contact creates a second 5-tuple entry on the FW 20 corresponding to the inside host and outside host Ho, which entry allows the outside host Ho to directly respond to communications from the inside host Hi.
If the inside host Hi wishes to send 212 a KOP NAK message to the outside host Ho, it uses the signaling connection to the RS 22, includes the IP address of the outside host Ho and integrity-protects the message. The FW 20 forwards 214 the integrity protected KOP NAK message to the RS 22. The RS 22 verifies the message and the 2-tuple 62 thereon transitions to the Block state 78 and forwards 216 the KOP NAK message to the outside host Ho.
The inside host Hi also has the option of sending 218 a KOP ACK message to the outside host Ho in response to the KOP REQ message. The FW 20 forwards 220 the KOP REQ message to the RS 22. The KOF embedded on the RS 22 holds an entry for the 5-tuple that is the same as the FW 5-tuple 60 previously described, which maintains an FW state corresponding to the 5-tuple of the inside host Hi and the outside host Ho. The FW state of the 5-tuple is set to the Pass state 68 when the RS 22 passes 222 the KOP ACK message to the outside host Ho. While the FW state of the 5-tuple is in the Pass state 68, the RS 22 will relay any information from the outside host Ho to the inside host Hi and visa versa.
The inside host Hi also has the option of sending a KOP RSP message to the outside host Ho in response to the KOP REQ message. This message will be communicated to the outside host Ho in the same manner as described for the KOP ACK message. The outside host Ho will respond to the KOP RSP message with another KOP REQ message, which contains the information requested by the KOP RSP message. The second KOP REQ message will be communicated to the inside host Hi in the same manner as described for the first KOP REQ message. Multiple of these described KOP RSP/KOP REQ message exchanges 224 are allowed.
The inside host Hi can send 226 a KOF FIN message to the outside host Ho to terminate a relay connection initiated through a KOP ACK message. The KOF FIN message is relayed to the outside host in the same manner as that described for the KOP ACK message.
   Note that KOF FIN and KOF ACK messages are used in case the RS 22 relays all traffic data.

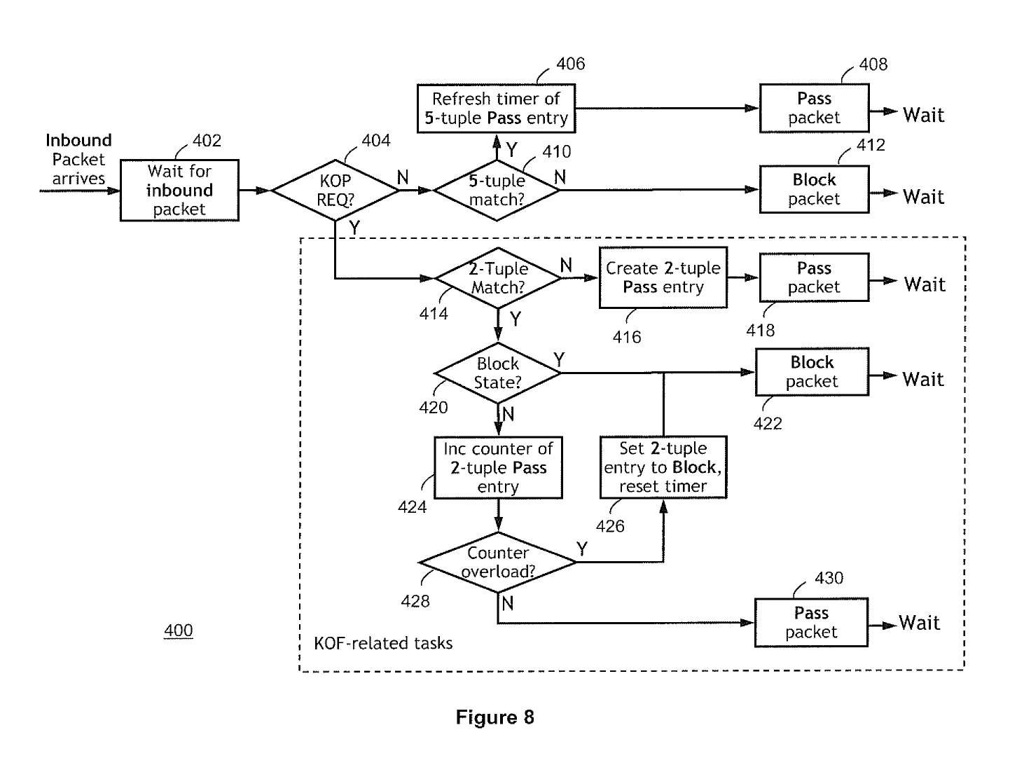

FIG. 8 is a flow chart illustrating a method 400 of handling inbound packets performed by the integrated KOF firewall 12 according to the embodiment depicted in FIG. 3 part a. The flow charts do not include state transitions shown in FIG. 5 that are due to timer expiry.

Referring to FIG. 8, the method 400 waits 402 for an inbound packet to arrive at the integrated KOF firewall 12. When an inbound packet arrives, the method determines 404 if the packet is a KOP REQ message. If it is not a KOP REQ message, the method determines 410 if the packet matches a 5-tuple entry already stored on the integrated KOF firewall 12. If there is a matching 5-tuple entry, then the method refreshes 406 a timer corresponding to the 5-tuple entry and passes 408 the packet to the inside host Hi. The method then returns to waiting for another inbound packet. Otherwise, if the method determines 410 that there is no matching 5-tuple entry on the integrated KOF firewall 12, then the packet is blocked 412, and the method returns to waiting for an inbound packet.

If the method 400 determines 404 that the packet is a KOP REQ message, then it determines 414 if the there is a 2-tuple entry on the integrated KOF firewall 12 that matches the packet. If there is no such matching 2-tuple entry, then the method creates 416 a 2-tuple entry for the packet and puts the entry into the pass state. The method then passes 418 the packet to the inside host Hi and returns to waiting for another inbound packet. If the method determines 414 that there is a matching 2-tuple entry, it determines 420 if that entry is in the block state. If the entry is in the block state, then the method blocks 422 the packet and returns to waiting for another inbound packet. However, if the method determines 420 that the 2-tuple entry is not in the block state, it increments a 2-tuple counter corresponding to the entry and then determines 428 if the counter has overloaded. If the counter has overloaded, the method sets 426 the 2-tuple entry to the block state and resets a timer for the entry. The method then blocks 422 the packet and returns to waiting for another inbound packet. However, if the counter has not overloaded, the method passes 430 the packet to the inside host Hi and then returns to waiting for another inbound packet.

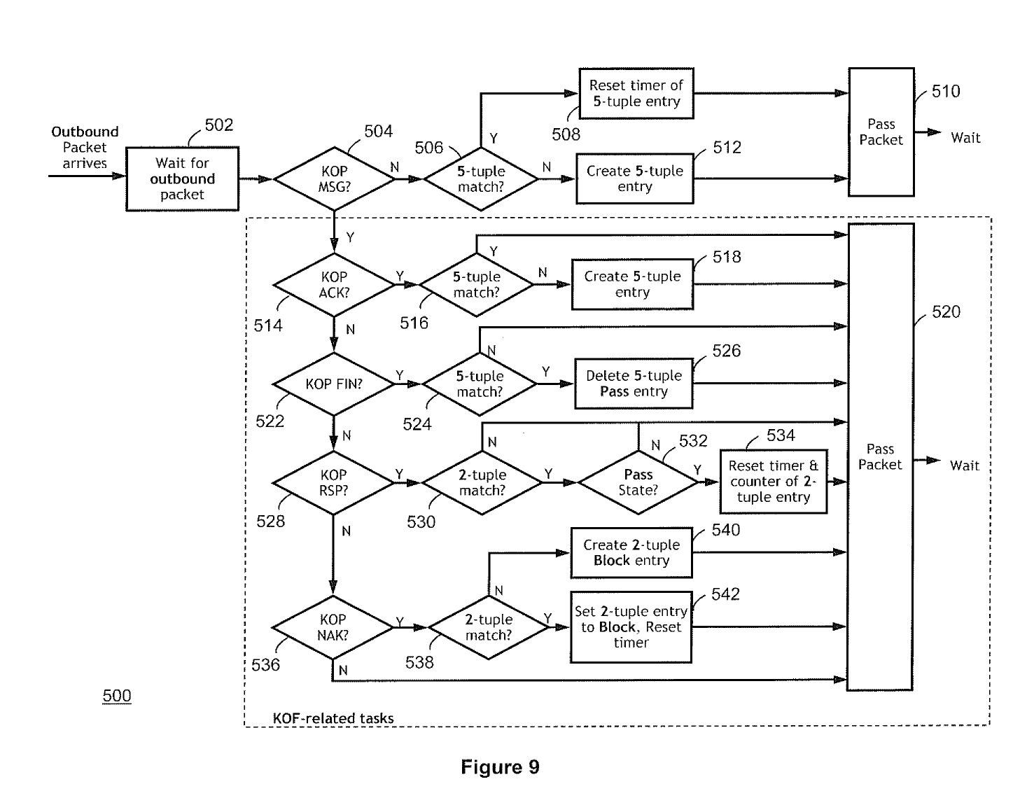

FIG. 9 is a flow chart illustrating a method 500 of handling outbound packets performed by the integrated KOF firewall 12 according to the embodiment depicted in FIG. 3 part a. The flow charts do not include state transitions shown in FIG. 5 that are due to timer expiry.

Referring to FIG. 9, the method 500 waits 502 for an outbound packet to arrive at the integrated KOF firewall 12. Upon receiving an outbound packet, the method determines 504 if the packet is a KOP message. If the packet is not a KOP message, the method then determines 506 if there is a 5-tuple entry on the integrated KOF firewall 12 that matches the packet. If there is such a matching 5-tuple entry, the method resets 508 the timer corresponding to the entry and passes 510 the packet towards the outside host Ho. The method then returns to waiting for another outbound packet. If there is no such matching 5-tuple entry, the method creates 512 a 5-tuple entry corresponding to the packet and passes 510 the packet towards the outside host Ho. The method then returns to waiting for another outbound packet.

If the method determines 504 that the packet is a KOP message, it then determines 514 if the packet is a KOP ACK message. In the affirmative case, the method determines 516 if there is a matching 5-tuple entry on the integrated KOF firewall 12. If there is such a matching 5-tuple entry, the method passes 520 the packet towards the outside host Ho and returns to waiting for another outbound packet. Otherwise, if there is no such matching 5-tuple entry the method creates 518 a 5-tuple entry corresponding to the packet and then passes the packet towards the outside host Ho. The method then returns to waiting for another outbound packet.

If the method determines 514 that the packet is not a KOP ACK message, it then determines 522 if the packet is a KOP FIN message. In the affirmative case, the method determines 524 if there is a matching 5-tuple entry on the integrated KOF firewall 12. If there is no such matching entry, the method passes 520 the packet towards the outside host Ho and returns to waiting for another outbound packet. Otherwise, if there is a matching 5-tuple entry the method deletes 526 the 5-tuple entry and then passes 520 the packet towards the outside host Ho. The method then returns to waiting for another outbound packet.

If the method determines 522 that the packet is not a KOP FIN message, it then determines 528 if the packet is a KOP RSP message. In the affirmative case, the method determines 530 if there is a 2-tuple entry on the integrated KOF firewall 12 that matches the packet. If there is no such matching 2-tuple entry, the method passes 520 the packet towards the outside host Ho and returns to waiting for another outbound packet. Otherwise, if there is a matching 2-tuple entry the method determines 532 if the entry is in the pass state. In the affirmative case, the method resets 534 the timer and counter corresponding to the 2-tuple entry, and then passes 520 the packet towards the outside host Ho. The method then returns to waiting for another outbound packet. Otherwise, if the method determines 532 that the 2-tuple entry is not in the pass state, it passes 520 the packet towards the outside host Ho and then returns to waiting for another outbound packet.

If the method determines 528 that the packet is not a KOP RSP message, it then determines 536 if the packet is a KOP NAK message. In the affirmative case, the method determines 538 if there is a 2-tuple entry on the integrated KOF firewall 12 that matches the packet. If there is no such matching 2-tuple entry, the method creates 540 on the integrated KOF firewall 12 a 2-tuple entry corresponding to the packet and sets the entry to the block state. The method then passes 520 the packet towards the outside host Ho and returns to waiting for another outbound packet. Otherwise, if there is a matching 2-tuple entry the method sets 542 the entry to the block state and resets the timer corresponding to the entry. The method then passes 520 the packet towards the outside host Ho and returns to waiting for another outbound packet.

If the method determines 536 that the packet is not a KOP NAK message, it passes 520 the packet towards the outside host Ho and returns to waiting for another outbound packet.

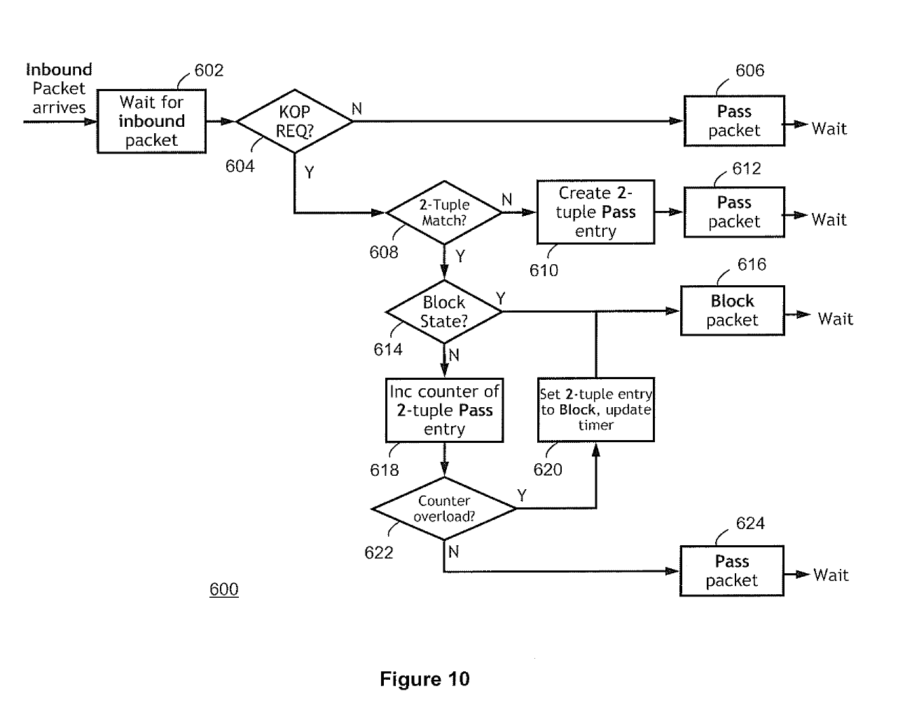

FIG. 10 is a flow chart illustrating a method 600 of handling inbound packets performed by the KOF 18 in series with the firewall 20 according to the embodiment depicted in FIG. 3 part b. The flow charts do not include state transitions shown in FIG. 6 that are due to timer expiry.

Referring to FIG. 10, the method 600 waits 602 for an inbound packet to arrive at the KOF 18. When an inbound packet arrives, the method determines 604 if the packet is a KOP REQ message. If it is not a KOP REQ message, the method passes 606 the packet to the FW 20 and returns to waiting for another inbound packet. If the packet is a KOP REQ message, the method determines 608 if the packet matches a 2-tuple entry already stored on the KOF 18. If there is no such matching 2-tuple entry, then the method creates 610 a 2-tuple entry corresponding to the packet and sets the entry to the pass state. The method then passes 612 the packet to the FW 20 and returns to waiting for another inbound packet. If the method determines 608 that there is a matching 2-tuple entry, the method then determines 614 if the entry is in the block state. In the affirmative case, the method blocks 616 the packet and returns to waiting for another inbound packet.

If the method determines 614 that the 2-tuple entry is not in the block state, it increments a 2-tuple counter corresponding to the entry, which is in the pass state, and then determines 622 if the counter has overloaded. If the counter has overloaded, the method sets 620 the 2-tuple entry to the block state and resets a timer for the entry. The method then blocks 616 the packet and returns to waiting for another inbound packet. However, if the counter has not overloaded, the method passes 624 the packet to the FW 20 and then returns to waiting for another inbound packet.

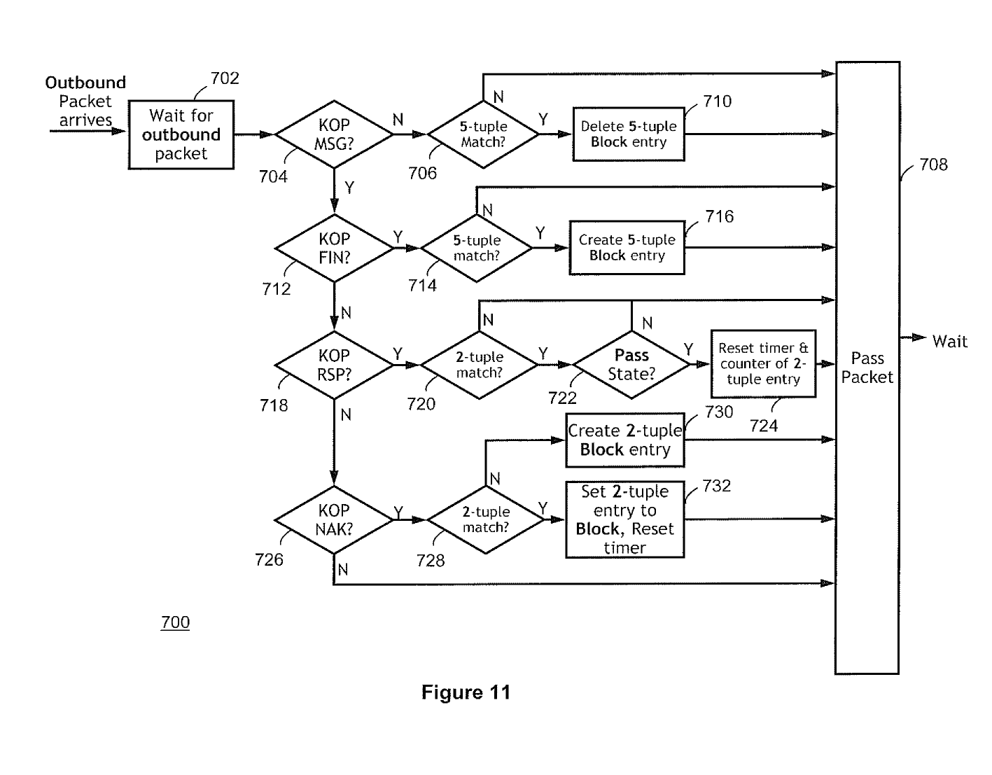

FIG. 11 is a flow chart illustrating a method 700 of handling inbound packets performed by the KOF 18 in series with the firewall 20 according to the embodiment depicted in FIG. 3 part b. The flow charts do not include state transitions shown in FIG. 6 that are due to timer expiry.

Referring to FIG. 11, the method 700 waits 702 for an outbound packet to arrive at the KOF 18. Upon receiving an outbound packet, the method determines 704 if the packet is a KOP message. If the packet is not a KOP message, the method then determines 706 if there is a 5-tuple entry on the KOF 18 that matches the packet. If there is no such matching 5-tuple entry, the method passes 708 the packet towards the outside host Ho. The method then returns to waiting for another outbound packet. If there is such a matching 5-tuple entry, the method deletes 710 the 5-tuple entry, which entry is in the block state, and passes 708 the packet towards the outside host Ho. The method then returns to waiting for another outbound packet.

If the method determines 704 that the packet is a KOP message, it then determines 712 if the packet is a KOP FIN message. In the affirmative case, the method determines 714 if there is a matching 5-tuple entry on the KOF 18. If there is no such matching 5-tuple entry, the method passes 708 the packet towards the outside host Ho and returns to waiting for another outbound packet. Otherwise, if there is a matching 5-tuple entry the method creates 716 a 5-tuple entry corresponding to the packet and sets the entry to the block state. The method then passes 708 the packet towards the outside host Ho. The method then returns to waiting for another outbound packet.

If the method determines 712 that the packet is not a KOP FIN message, it then determines 718 if the packet is a KOP RSP message. In the affirmative case, the method determines 720 if there is a matching 2-tuple entry on the KOF 18. If there is no such matching 2-tuple entry, the method passes 708 the packet towards the outside host Ho and returns to waiting for another outbound packet. Otherwise, if there is a matching 2-tuple entry the method determines 722 if the entry is in the pass state. In the affirmative case, the method resets 724 the timer and counter corresponding to the entry, and then passes 708 the packet towards the outside host Ho. The method then returns to waiting for another outbound packet. Otherwise, if the matching 2-tuple entry is not in the pass state, the method passes 708 the packet towards the outside host Ho and returns to waiting for another outbound packet.

If the method determines 718 that the packet is not a KOP RSP message, it then determines 726 if the packet is a KOP NAK message. In the affirmative case, the method determines 728 if there is a 2-tuple entry on the KOF 18 that matches the packet. If there is no such matching 2-tuple entry, the method creates 730 on the KOF 12 a 2-tuple entry corresponding to the packet and sets the entry to the block state. The method then passes 708 the packet towards the outside host Ho and returns to waiting for another outbound packet. Otherwise, if there is a matching 2-tuple entry the method sets 732 the entry to the block state and resets the timer corresponding to the entry. The method then passes 708 the packet towards the outside host Ho and returns to waiting for another outbound packet.

If the method determines 726 that the packet is not a KOP NAK message, it passes 708 the packet towards the outside host Ho and returns to waiting for another outbound packet.

### Application to Network Address Translators

Most NATs combine network address or network address/port translation with a firewall function. In these cases, the same KOF methods as discussed above can be applied. Due to the NAT, however, the internal address and port numbers of the inside host Hi are different than its public address and port numbers translated by the NAT. Therefore, the outside host Ho may not know how to reach the inside host Hi. Further, the inside host Hi may not know its public IP address. This situation affects KOP messages as well as the establishment transport connections.

If KOP messages are supported by a conventional transport type (UDP or TCP), the host can use Connection Traversal Utilities for NAT (STUN) proposed by the IETF (RFC 5389) to find its KOP public IP address and port number. The inside host Hi can publish these data in DNS so that they are publically available.

The inside host Hi can also use the STUN method to find the public IP address and port number for a transport connection it wishes to set up. The outcome of the STUN method can then be forwarded to the remote host in the KOP REQ message at connection setup. If the remote host also resides behind a NAT, it uses the same STUN method and returns its own public IP address and port number in the KOP ACK or KOP RSP message. Then both of the inside and outside hosts can forward transport packets to each other, which action will create 5-tuple entries on the respective NATs. This technique, often referred to as “hole punching”, enables a transport connection to be established between both hosts.

The same principal methods apply when the KOP messages are multiplexed onto the transport connection, e.g. via IP Extension header (IPv6) or IP Option header (IPv4), or if they are embedded into the transport layer. This method has the downside that there is not only one KOP address and port number that can be published in the host's DNS server. In this case, a RS can be used. The RS performs the STUN service for both hosts (if they are behind NATs) and includes them into the KOP message exchange.

Finally, if one or both NATs are symmetric NATs, the function of the RS could be extended from KOP message exchange to the tunneling of transport data.

Numerous modifications, variations and adaptations may be made to the embodiments of the invention described above without departing from the scope of the invention, which is defined in the claims.

What is claimed is:

1. A method of establishing a connection between a first host system and a second host system through a firewall protecting the second host system, comprising:
performing by a knock-on-feature (KOF) apparatus the steps of:
receiving a first message sent by the first host system;
determining the first message is of a first type for establishing the connection between the first host system and a second host system;
determining respective addresses of the first and second hosts systems from the first message;
determining if any state information exists on the KOF apparatus for a 2-tuple corresponding to the addresses of the first and second host systems; and
sending the first message to the first host system if no said state information for the 2-tuple exists on the KOF apparatus.

2. The method of claim 1 wherein the step of sending comprises initializing and starting a first timer for the 2-tuple.

3. The method of claim 2 wherein the step of sending further comprises initializing and incrementing a message counter for the 2-tuple.

4. The method of claim 3 further comprising:
checking the first timer if said state information for the 2-tuple exists on the KOF apparatus; and
removing said state information on the KOF apparatus if the first timer has expired.

5. The method of claim 4 further comprising performing the following steps if said state information for the 2-tuple exists on the KOF apparatus:
checking a count of the message counter;
starting a second timer for the 2-tuple and dropping the first message if the count has reached a predetermined value; and
sending the first message to the second host system if the count has not reached the predetermined value.

6. The method of claim 5 further comprising performing the following steps if said state information for the 2-tuple exists on the KOF apparatus:
checking the second timer;
dropping the first message if the second timer has not expired; and
removing all said state information for the 2-tuple on the KOF apparatus if the second timer has expired.

7. The method of claim 6 further comprising:
receiving a second message sent by the second host system;
determining that the second message is of a second type for requesting information from the first host system in response to the first message; and
sending the second message to the first host system.

8. The method of claim 1 further comprising:
determining an amount of state information existing on the KOF apparatus with respect to the second host system; and
combining, responsive to the amount exceeding a predetermined maximum, state information of two host system pairs, each pair comprising the second host system and another host system that is different in each pair, into state information for one host system pair comprising the address of the second host system and an address prefix common to respective addresses of the other host systems of the two host system pairs.

9. The method of claim 8 further comprising:
setting a combined timer for said one host system pair to a minimum of respective first timers of the two host system pairs; and
setting a combined message counter for said one host system pair to a maximum of respective message counters for the two host system pairs.

10. The method of claim 1 further comprising:
receiving a third message sent by the second host system;
determining the third message is of a third type for terminating the connection between the first and second host systems; and
removing from the KOF, responsive to receiving the third type of message, 5-tuple state information for the 2-tuple, the 5-tuple state information including in addition to the 2-tuple and with respect to the connection: an indication of protocol type, an indication of a first port of the first host system, and an indication of a second port of the second host system.

11. The method of claim 10, where the KOF apparatus is part of the firewall, the method further comprises:
receiving a fourth message sent by the second host system;
determining the fourth message is of a fourth type for initiating the connection responsive to the first message; and
starting a third timer with respect to the 5-tuple.

12. The method of claim 11 further comprising:
receiving communication traffic sent by the first host system and destined to the second host system;
checking the third timer;
determining if state information for the 5-tuple exists on the firewall; and
passing the communication traffic responsive to the third timer having not expired and responsive to the state information for the 5-tuple existing on the firewall.

13. The method of claim 5, where the KOF apparatus is external to and in series with the firewall, the method further comprises:
checking the second timer;
dropping the first message if the second timer has not expired;
removing, if the second timer has expired, all said state information for the 2-tuple on the KOF apparatus including 5-tuple state information for the 2-tuple, the 5-tuple state information including in addition to the 2-tuple and with respect to the connection: an indication of protocol type, an indication of a first port of the first host system, and an indication of a second port of the second host system.

14. The method of claim 1, where the KOF apparatus is part of a relay server that is external to the firewall, the step of receiving comprises receiving the first message over a prior established first signaling connection between the first host system and the relay server; and the step of sending comprises sending the first message to the second host system over a prior established signaling connection between the second host system and the relay server.

15. The method of claim 1, wherein the step of sending further comprises:
creating on the KOF a 2-tuple entry corresponding to the addresses of the first and second host systems; and
setting that 2-tuple entry to a pass state.

16. The method of claim 10, wherein removing further comprises:
creating on the KOF a 2-tuple entry corresponding to the addresses of the first and second host systems; and
setting that 2-tuple entry to a block state.

17. The method of claim 1 further comprising:
determining an amount of state information existing on the KOF apparatus with respect to the first host system; and
combining, responsive to the amount exceeding a predetermined maximum, state information of two host system pairs, each pair comprising the first host system and another host system that is different in each pair, into state information for one host system pair comprising the address of the second host system and an address prefix common to respective addresses of the other host systems of the two host system pairs.

18. A firewall comprising a knock-on-feature (KOF) apparatus for performing the method of claim 1.

19. A relay server comprising a knock-on-feature (KOF) apparatus for performing the method of claim 1.

20. A knock-on-feature (KOF) system for performing the method of claim 1.
